(19) United States
(12) Patent Application Publication
(10) Pub. No.: US 2013/0128688 A1
(43) Pub. Date: May 23, 2013

(54) Flow Reversing Static Mixer and Method

(71) Applicants: Michael B. Doolin, Billings, MT (US); Barry M. Beringer, Billings, MT (US)

(72) Inventors: Michael B. Doolin, Billings, MT (US); Barry M. Beringer, Billings, MT (US)

(21) Appl. No.: 13/300,194

(22) Filed: Nov. 18, 2011

(51) Int. Cl. B01F 5/06; B01F 15/02; B01F 5/00

(52) U.S. Cl. 366/163.2; 366/336; 366/340

(57) ABSTRACT

A static mixer includes first and second tubular housings which define elongated internal cavities. Dividers divide each internal cavity into a plurality of separate and sequential flow paths for the fluid mixture. Each separate flow path extends between the opposite ends of each housing, reverses direction substantially adjacent to an end of each housing, and conducts the fluid mixture in a direction opposite of the fluid mixture conducted by one of a preceding or succeeding flow path.

This invention relates to static mixing, and more particularly to a new and improved static mixer and method for continuously mixing, dispersing and subdividing a non-homogeneous input fluid mixture of constituent liquid and/or solid particulate substances which are usually not soluble or chemically combinable one another to thereby create a considerably more homogeneous output fluid mixture of the constituent substances.

### BACKGROUND OF THE INVENTION

A static mixer is a device which does not require an external motor and mixing paddles or stirrers to mix or combine different substances. In most cases, the static mixer has no moving parts. Instead the static mixer uses one or more stationary mixing structures which cause the fluid mixture passing through the static mixer to experience abrupt variations in velocity and pressure. The variations in velocity and pressure create turbulence in the fluid mixture. The turbulence creates shear forces in the fluid mixture which mix, disperse and subdivide volumetric quantities of the constituents throughout the fluid mixture. The effectiveness of the mixing is therefore directly related to the ability of the static mixing structures to induce turbulence in the fluid mixture.

Particularly in the situation where solid particulate matter is one of the constituents of the fluid mixture, it is desirable to subdivide and separate the solid particulate matter into very small volumetric quantities. In the case of grains of solid material, the individual grains may adhere together in clumps, even when surrounded in liquid and subjected to turbulence. Under such circumstances, the clumps may be uniformly mixed within the fluid mixture, but the output mixture may still lack the desired level of homogeneity because the clumps have not been subdivided into small volumetric quantities. Under such circumstances, the static mixer lacks the capability to effectively subdivide the solid particulate matter constituents even though the clumps are uniformly distributed within the fluid.

Subdividing a solid particulate constituent of a fluid mixture is particularly important when the solid particulate constituent must be distributed over a large surface after it has been mixed in the fluid mixture. For example, in the case where the solid particulate clay particles are used as a drilling fluid to coat a borehole which has been drilled or otherwise formed in an earth formation, if the clay particles have not been subdivided into very small volumetric quantities in a liquid such as water, the coating will not be uniform because clumps of the clay particles will exist in the fluid mixture. The clumps of the clay particles create a non-uniform distribution when they interact with the earth formation. Further still, a greater amount of clay particles will be required to to obtain an adequate coating of the earth formation, due to the nonuniformity of the fluid mixture. More clay will be required in the fluid mixture because the mixture is not homogeneous enough to assure an adequate amount of clay particles will be distributed over the earth formation. This situation usually creates higher costs because more of clay is required to coat the borehole than would otherwise be necessary if a more thorough distribution of uniformly and finely subdivided volumetric quantities of the clay particles was achieved in the output fluid mixture. This example illustrates that the effectiveness of the static mixer directly affects costs of its use.

In typical use, a pressurized flow of the input fluid mixture is delivered to the static mixer, and enough pressure remains in the flow of the homogenized output fluid mixture to allow it to be applied or used in a desired manner. Because the static mixer consumes energy from the pressurized input fluid mixture to obtain the energy to accomplish the static mixing, it is desirable to minimize the amount of energy loss within the static mixer, without sacrificing the creation of sufficient turbulence to achieve thorough mixing, dispersal and subdivision of the constituents within the output fluid mixture. Minimizing this energy loss reduces the cost of operation, by reducing the amount of energy consumed by the motors driving the pumps which supply the pressurized input fluid mixture to the static mixer.

The effectiveness or efficiency of the static mixer depends upon the length of the mixing flow path within the static mixer and the effectiveness of the static mixing structures which create the abrupt variations in velocity and pressure to induce the turbulence within the flow path. A greater degree of turbulence generally translates into a more thorough dispersal and subdivision of the constituents in the fluid mixture. Furthermore, some configurations and types of static mixing structures are more effective in creating turbulence and shear effects, without consuming excessive energy from the pressurized input fluid mixture. The degree to which the constituents are uniformly mixed, dispersed and subdivided by the static mixer may not directly correlate to the amount of pressure drop or energy consumed by the mixer.

Another consideration relates to the physical size of the static mixer. Many applications for static mixers do not permit physically large sized devices to be used because of space constraints. Large static mixers can generally achieve more thorough mixing by using more static mixing structures, or lengthening the path through which the fluid mixture must flow during mixing, thereby increasing the overall physical size of the static mixer.

### SUMMARY OF THE INVENTION

The static mixer of this invention uses a plurality of reversing serpentine flow paths and static mixing structures located in the flow paths to better and more completely homogenize a relatively non-homogenous input fluid mixture supplied under pressure on a continuous basis. The static mixer is effective in homogenizing and subdividing the constituents of the input fluid mixture, including input fluid mixtures which contain solid particulate matter. The static mixer very effectively subdivides clumps of solid particulate matter to thoroughly disperse the solid particular manner in very small volumetric quantities throughout the fluid mixture. The static mixer achieves improved mixing without consuming excessive energy from the flow of pressurized input fluid mixture and by using smaller and more energy efficient equipment. The type, organization and arrangement of the structural mixing elements results in a relatively compact sized static mixer which can be used in many beneficial applications and which can be retrofitted into existing applications.

The static mixer of the present invention achieves these and other desirable benefits and improvements by mixing constituents of an input fluid mixture into a more homogenized output fluid mixture. The static mixer includes a first elongated tubular housing which defines an elongated internal cavity extending between a first end of the first housing and a second opposite end of the first housing. An inlet port is connected to the first end of the first housing to conduct the input fluid mixture into the internal cavity of the first housing. The static mixer also includes a second elongated tubular housing which defines an elongated internal cavity extending between a first end of the second housing and a second opposite end of the second housing. A conduit is connected between the first and second housings to conduct the fluid mixture from the internal cavity of the first housing to the internal cavity of the second housing. An outlet port is connected to the second end of the second housing to conduct the fluid mixture from the second housing as the output fluid mixture. First and second dividers are respectively located within the internal cavities of the first and second housings to divide each internal cavity into a plurality of separate and sequential flow paths for the fluid mixture. Each separate flow path extends substantially between the first and second ends of each housing. Each flow path reverses direction substantially adjacent to an end of each housing. Each flow path in the sequence in each housing also conducts the fluid mixture in a direction opposite of the fluid mixture conducted by one of a preceding or succeeding flow path in each housing.

The static mixer may include some or all of the following-described subsidiary features.

The internal cavity in at least one of the first or second housings is an elongated cylindrical cavity. The divider in the internal cavity is a multi-fin structure defined by a plurality of at least three fin plates which extend radially outward from an axis of the cylindrical internal cavity at different circumferentially spaced locations to divide the cylindrical cavity into a plurality of at least three flow paths which are sector-shaped in cross-section. Some of the fin plates terminate longitudinally short of the ends of the one housing to create pass-through openings from one flow path to the next sequential flow path. Static mixing structures are connected to the fin plates within at least one of the sector-shaped flow paths to induce turbulence and shear effects in the fluid mixture flowing past the static mixing structures. The static mixing structures include vanes which extend outward from the fin plates into the sector shaped flow paths or perforated baffle plates which extend entirely across the sector shaped flow path.

In another case, the divider in the elongated cylindrical internal cavity is a hollow center tube located at and extending along an axis of the cylindrical internal cavity from one end of the housing and terminating at an open end which is separated from the other end of the housing. The center tube divides the cylindrical internal cavity into an annular-shaped flow path at the exterior of the center tube and a center flow path within the hollow center tube. Static mixing structures are preferably connected to the exterior of the center tube to induce turbulence and shear effects in the fluid mixture flowing past the static mixing structures in the annular shaped flow path. The static mixing structures may include vanes which extend radially outward from the exterior of the center tube and toward the housing. The static mixing structures may also include annular-shaped perforated baffle plates which extend radially outward from the exterior of the center tube to contact the cylindrical internal cavity of the housing to assist in supporting the center tube in a cantilever manner from one end of the housing. A concave-shaped flow reverser is positioned within the internal cavity with the concave shape spaced from and facing toward the open end of the center tube to direct the fluid mixture in the annular flow path into the open end of the center tube. The flow reverser may be movable in position within the internal cavity to control the flow of fluid mixture into the open end of the center tube. A venturi structure is positioned within the center tube adjacent to the open end to create a reduced pressure to draw the fluid mixture into the center flow path. A baffle assembly is positioned within the center tube to induce turbulence and shear effects in the fluid mixture flowing in the center flow path.

The invention also involves a method of creating a homogeneous output fluid mixture from an input fluid mixture having substantially less homogeneity. The method comprises conducting the input fluid mixture through a static mixing apparatus of the type described to create the homogeneous output mixture.

A more complete appreciation of the present invention and its scope may be obtained from the accompanying drawings, which are briefly summarized below, from the following detailed descriptions of presently preferred embodiments of the invention, and from the appended claims.

### BRIEF DESCRIPTION OF THE DRAWINGS

FIG. 1 is a perspective view of a static mixer which incorporates the present invention.

FIG. 2 is an exploded perspective view of the static mixer shown in FIG. 1.

FIG. 3 is a vertical section view of the static mixer shown in FIGS. 1 and 2.

FIG. 4 is a schematic view of five flow paths within the static mixer shown in FIGS. 1-3, illustrated relative to simplified forms of a lie-shaped flow divider and a center tube flow divider shown in FIGS. 2 and 3.

FIG. 5 is a cross-sectional view taken substantially in the plane of line 5-5 in FIG. 3.

FIG. 6 is a cross-sectional view taken substantially in the plane of line 6-6 in FIG. 3.

FIG. 7 is a perspective view of a half sphere flow reverser attached to an end plate of the mixer shown in FIGS. 2 and 3.

FIG. 8 is a perspective view of a baffle assembly of the mixer shown in FIGS. 2 and 3.

FIG. 9 is a perspective view of one baffle plate of the baffle assembly shown in FIG. 8.

FIG. 10 is an enlarged partial view of a terminal end portion of a center tube divider and a baffle assembly shown in FIG. 3.

FIG. 11 is an enlarged partial view of an end cap flow reverser attached to the housing of the mixer, as an alternative to a flow reverser shown in FIGS. 2, 3 and 7.

FIG. 12 is an enlarged section and partial view of another type of flow reverser positioned within an end of the housing of the mixer, compared to the flow reversers shown in FIGS. 2, 3, 7 and 11.

FIG. 13 is a perspective view of the flow reverser shown in FIG. 12.

### DETAILED DESCRIPTION

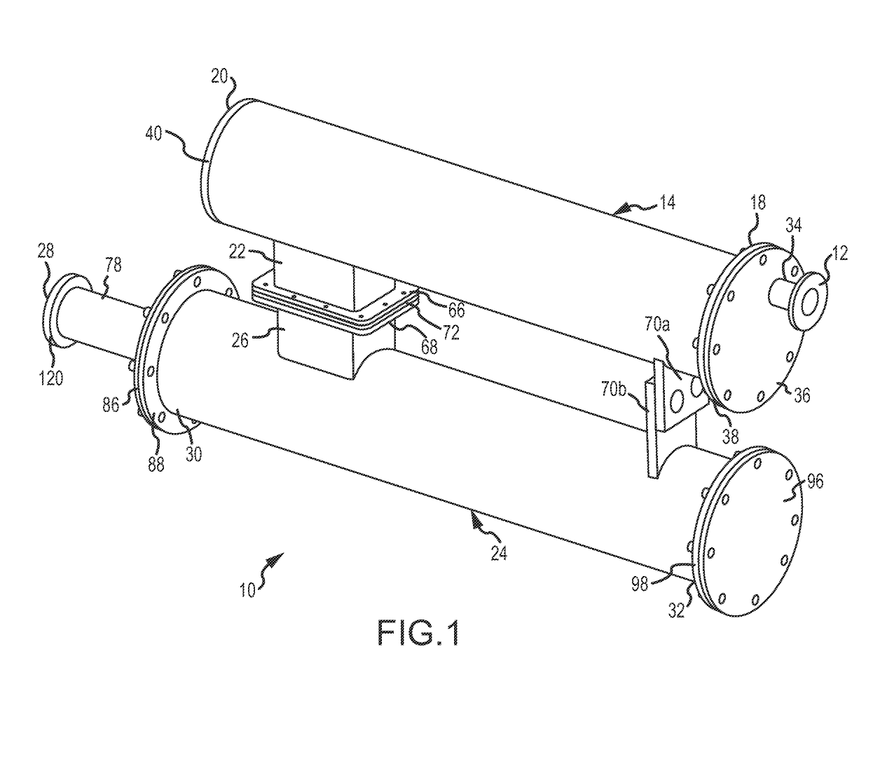

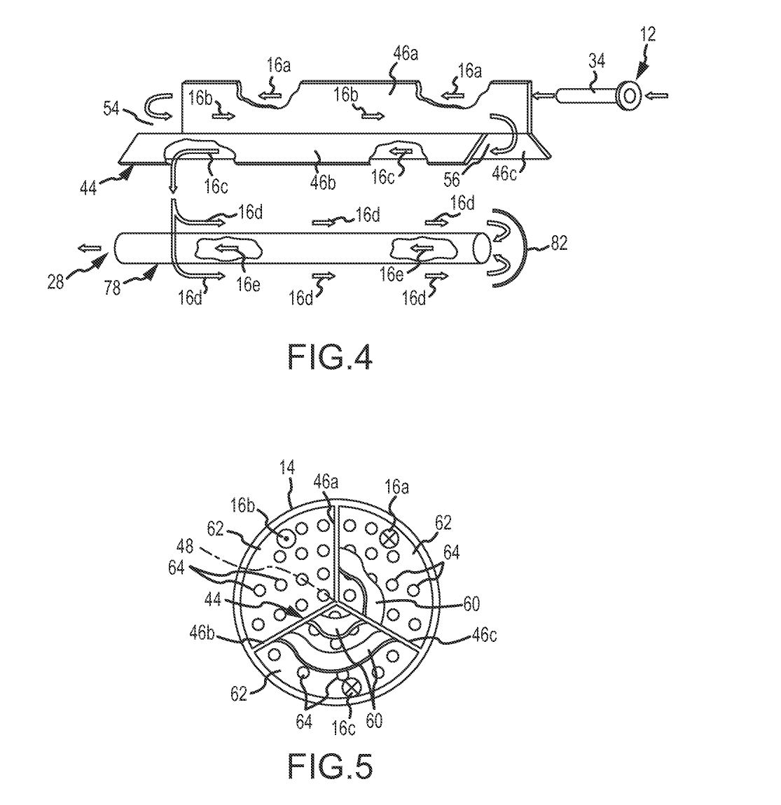

A static mixer 10 which incorporates the present invention is shown in FIGS. 1-4. The static mixer 10 receives an input fluid mixture having non-homogeneous constituents at an inlet port 12. The non-homogeneous input fluid mixture is first confined within a first housing 14 in a plurality of reversing, serpentine flow paths 16a, 16b and 16c. The input fluid mixture flows in a first direction in a first flow path 16a from an entry end 18 of the housing 14 to a closed end 20 of the housing 14 (right to left as shown), then reverses direction at the closed end 20 and flows in a second flow path 16b in a second opposite direction to the entry end 18 (left to right as shown), and then reverses direction again at the entry end 18 and flows in a third flow path 16c in the first direction (right to left as shown). After passing through the flow paths 16a-16c, the fluid mixture leaves the first housing 14 through an exit conduit 22 and enters a second housing 24 through an entrance conduit 26.

The fluid mixture is confined within the second housing 24 until it leaves the second housing 24 as a more or thoroughly homogenized output fluid mixture at an outlet port 28 at an outlet end 30 of the second housing 24. The fluid mixture enters the second housing 24 through the entrance conduit 26 at the outlet end 30 of the second housing 24 and flows in a fourth flow path 16d in the opposite direction (left to right as shown). The fluid mixture then reverses direction at a closed end 32 of the second housing 14 and flows in the first direction (right to left as shown) within the second housing 24 until it exits the static mixer 10 as the outlet mixture at the outlet port 28.

Each of the housings 14 and 24 therefore confine the fluid mixture flowing in those housings 14 and 24 into a plurality of separate and sequential flow paths. Flow paths 16a-16c exist within the housing 14. Flow paths 16d and 16e exist within the housing 24. Each flow path 16a-16c within each housing 14 and 24 extends substantially between the opposite ends of that housing. Each flow path 16a-16e reverses direction substantially adjacent to an end of the housing. Each flow path in sequence in each housing conducts the fluid mixture in a direction opposite from the direction that the fluid mixture is conducted by a preceding or succeeding flow path in the housing.

Various static mixing structures are located within each of the flow paths 16a-16e to create changes in flow direction, flow rate, flow deflection, flow division and to create pressure variations in the fluid mixture, all of which create turbulence and shear effects in the fluid mixture. The turbulence and shear effects disburse and subdivide volumetric quantities of the constituents of the input fluid mixture and thereby subdivide, mix or homogenize the constituents into the thoroughly or more homogenized output mixture delivered from the output port 28, as the fluid mixture flows through the static mixer 10.

The mixing or homogenization occurs on a continuous basis when the input mixture is continuously supplied to the input port 12. The extent of mixing or homogenization is related to the length and number of the flow paths 16a-16e and the effects of the static mixing structures included in those flow paths. The serpentine reversing directions of the flow paths 16a-16e achieve a considerable amount of mixing within a relatively limited amount of space consumed by the static mixer 10. As an example of a configuration which conserves space, the housings 14 and 24 have similar lengths, are oriented adjacent and parallel to one another, and are connected together preferably with first housing 14 located vertically above the second housing 24.

The inlet port 12 is defined by an inlet tube 34 that extends through an end plate 36. A flange 38 extends outward from the entry end 18 of the housing 14, and the end plate 36 connects to the flange 38 to close the entry end 18 of the housing 14. The inlet tube 34 is hermetically sealed to the end plate 36 by welding, for example. The inlet tube 34 connects to a conduit (not shown) which supplies the input fluid mixture under pressure. The input fluid mixture is delivered with enough pressure to push the fluid mixture through the mixer 10 and deliver the output mixture with sufficient pressure for use, despite energy losses caused by the serpentine flow reversals and the changes in flow direction, flow rate, flow deflection, flow division and pressure caused by the static mixing structures as the fluid mixture flows through the mixer 10.

At the closed end 20 of the housing 14, an end plate 40 is attached to the upper housing 14 by welding, for example. The end plates 40 and 36 enclose a cylindrical interior cavity 42 of the first housing 14.

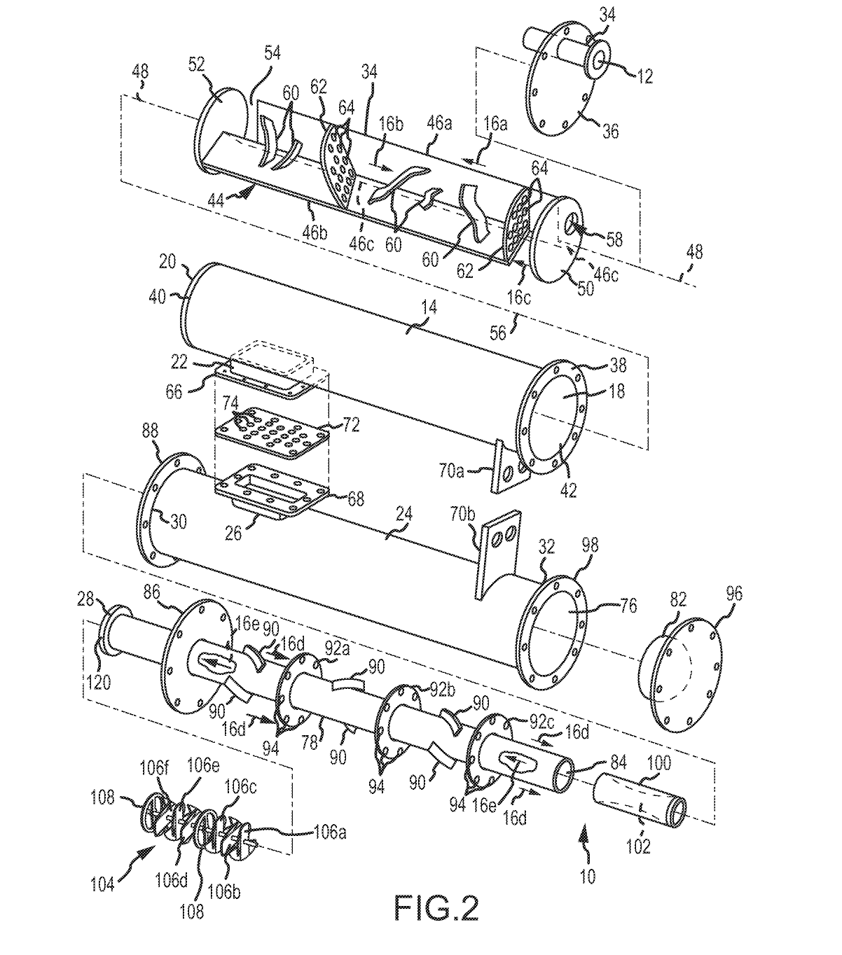

The flow paths 16a-16c are established in the first housing 14 by a divider 44 which is positioned with the interior cavity 42 of the housing 14. The divider 44 is a multi-fin structure which, in this example, has a Y-shaped cross-sectional configuration created by three elongated fin plates 46a, 46b and 46c. The plates 46a, 46b and 46c are commonly connected to one another along longitudinal sides that are co-located at a central axis 48 of the cavity 42, as shown in FIG. 2-5. The first flow path 16a is defined by the sector of the cylindrical cavity 42 between the fin plates 46a and 46c and the inside surface of the housing 14 (FIG. 5). In a similar manner, the second flow path 16b is defined by the sector of the cylindrical cavity 42 between the fin plates 46a and 46b and the inside surface of the housing 14 (FIG. 5), and the third flow path 16c is defined by the sector of the cylindrical cavity 42 between the fin plates 46b and 46c and the inside surface of the housing 14 (FIG. 5). The outer sides of the fin plates 46a, 46b and 46c are positioned adjacent to the interior surface of the upper housing 14 to confine the fluid mixture in the passageways 16a, 16b and 16c along the length of the fin plates 46a, 46b and 46c. Using more than the three fin plates 46a-46c in a multi-fin divider structure will create more than the three sector shaped flow paths through cylindrical cavity 42 of the housing 14.

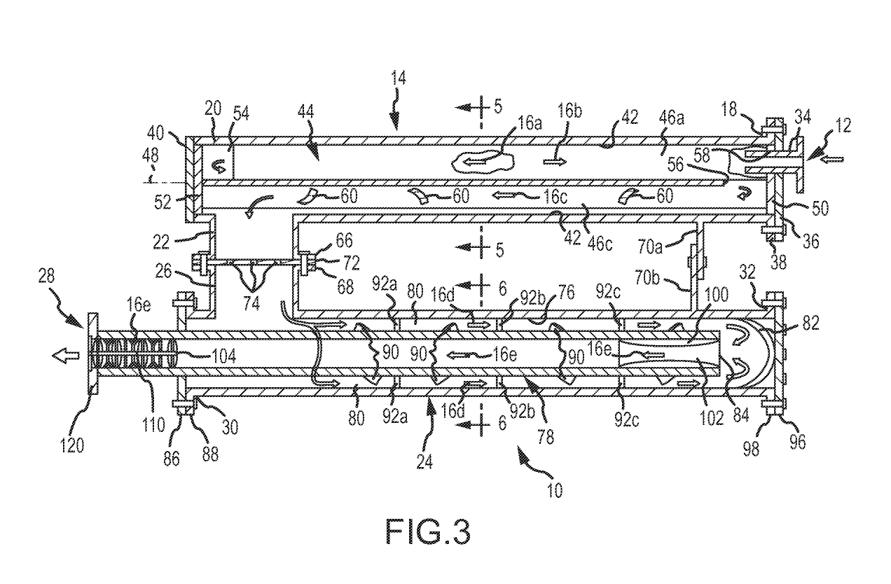

A first transverse circular plate 50 is attached the short transverse sides of the fin plates 46a and 46c at one end of the Y-shaped divider 44, and a second transverse circular plate 52 is attached to the short transverse sides of the fin plates 46a and 46b at the other end of the divider 44, as shown in FIGS. 2 and 3. The fin plate 46a stops short of contacting the second circular plate 52 to create a pass-through opening 54 at the end of the first flow path 16a and at the beginning of the second flow path 16b. The flow reversal at the end of the first flow path 16a and the beginning of the second flow path 16b occurs in the pass-through opening 54. The fin plate 46b stops short of contacting the first circular plate 50 to create a pass-through opening 56 at the end of the second flow path 16b and the beginning of the third flow path 16c. The flow reversal at the end of the second flow path 16b and the beginning of the third flow path 16c occurs in the pass-through opening 56. The circular plates 50 and 52 contribute rigidity to the Y-shaped divider 44 and help define the pass-through openings 54 and 56 and the flow paths 16a-16c.

An opening 58 is formed in the first circular plate 50 between the fin plates 46a and 46c, as shown in FIGS. 2 and 3. An end of the inlet tube 34 extends through the opening 58 to deliver the input fluid mixture into the beginning of the first flow path 16a, when the Y-shaped divider 44 is inserted into the cavity 42 of the housing 14. The discharge end of the inlet tube 34 projects downstream past the first circular plate 50 into the first flow path 16a. The transition from the discharge end of the inlet tube 34 into the first flow path 16a is abrupt and substantial, due to the substantially larger cross-sectional area of the sector shaped first flow path 16a, compared to the cross-sectional size of the inlet tube 34. This transition creates an abrupt and substantial pressure drop and an abrupt and substantial reduction in the flow rate, which induce considerable turbulence and shear in the input fluid mixture upon entering the first flow path 16a. The resulting turbulence and shear causes mixing.

When located in the cavity 42, the first circular plate 50 is located adjacent to the end plate 36 at the entry end 18 of the housing 14, and the second circular plate 52 is located adjacent to the end plate 40 at the closed end 20 of the housing 14. The Y-shaped divider 44 is inserted in the cavity before the end plate 36 is connected to the flange 38. Although not shown, an access port can be formed through the end plate 40 of the housing 14, to allow the insertion of an tool to contact the second circular in plate 52 and force the Y-shaped divider 44 out of the cavity 42, if necessary for repair or replacement. The access port in the end plate 40 is normally closed to prevent leakage of the fluid mixture.

In general, the cross-sectional sizes of the pass-through openings 54 and 56 are larger than the cross-sectional size of the sector-shaped flow paths 16a-16c. The increase in cross-sectional size of the pass-through openings 54 and 56 creates an abrupt and substantial pressure drop and reduction in the flow rate as the fluid mixture reverses direction to enter the next sequential flow path. The abrupt pressure drop and flow reduction, combined with the flow reversal, induces significant turbulence and shear in the mixture as it passes through the pass-through openings, thereby contributing to further mixing of the constituents of the fluid mixture.

Additional shear effects and pressure and velocity changes are created along the length of each flow path 16a, 16b and 16c by various static mixing structures which are attached to the fin plates 46a, 46b and 46c, as shown in FIGS. 2 and 3. These static mixing structures interact with the fluid mixture flowing through those flow paths 16a-16c to create pressure and velocity changes and disruptions which lead to turbulence and shear, all of which contribute to mixing as the fluid mixture flows through the flow paths 16a-16c.

As shown in FIG. 2, the static mixing structures in the flow paths 16a-16c include vanes 60 which are attached to the fin plates 46a-46c and extend into the fluid mixture flowing in the flow paths 16a-16c. The vanes 60 change the direction, velocity and pressure of the fluid mixture in the immediate vicinity of the vanes 60, thereby creating turbulence and shear effects which contribute to mixing the constituents of the fluid mixture. The vanes 60 can assume many different configurations and still create mixing effects.

Perforated baffle plates 62 also preferably extend wholly across each of the flow paths 16a-16c, as shown in FIGS. 2 and 3. The fluid mixture flowing through holes 64 in the baffle plates 62 experiences turbulence and shear effects, caused by abrupt pressure and velocity changes as the fluid mixture passes through the holes 64. The resulting turbulence and shear effects from the baffle plates 62 also contribute to mixing and homogenizing of the fluid mixture. The vanes 60 and the perforated baffle plates 62 are examples of static mixing structures; other types of static mixing structures may also be used.

After the fluid mixture flows through the third flow path 16c, the fluid mixture exits the housing 14 at the end of the third flow path 16c through the exit conduit 22. The exit conduit 22 communicates with the housing 14 at a position between the fin plates 46b and 46c and adjacent to the second circular plate 52, at the end of the third flow path 16c. The fluid mixture exits the exit conduit 22 and enters the entrance conduit 26 of the second housing 24, at a location adjacent to the outlet end 30 of the housing 24. Flanges 66 and 68 on the ends of the conduits 22 and 24 are connected to each other by nuts and bolts, for example, to connect the conduits 22 and 24 as a single conduit extending between the housings 14 and 24.

In addition to the connection between the exit conduit 22 and the entrance conduit 26 at the ends 20 and 30 of the housings 14 and 24, a pair of overlapping support brackets 70a and 70b support the other ends 18 and 32 of the housings 14 and 24, respectively. The overlapping brackets 70a and 70b extend from the housings 14 and 24, respectively, and are connected together by bolts and nuts, for example. The connection of the conduits 22 and 26 at the flanges 66 and 68, and the connection of the overlapping brackets 70a and 70b rigidly connect the housings 14 and 24 together.

A rectangular perforated plate 72 is positioned between the flanges 66 and 68 when the flanges 66 and 68 are connected. The fluid mixture flows though holes 74 of the perforated plate 72 before entering a cylindrical interior cavity 76 of the housing 24. The fluid mixture flowing through the holes 74 experiences pressure and velocity changes which cause turbulence and induce shear to contribute to the mixing and homogenization of the fluid mixture. The cross-sectional size of the exit conduit 22 is greater than the cross-sectional size of the flow path 16c, causing pressure and velocity changes that result in turbulence and shear effects. The turn in flow direction from the third flow path 16c into the exit conduit 22, and the turn in flow direction from the entrance conduit 26 into the fourth flow path 16d, also create further pressure and velocity changes that cause turbulence and shear effects to contribute to mixing the constituents of the fluid mixture.

The fourth and fifth flow paths 16d and 16e are established in the second housing 24 by a hollow center tube divider 78 that is located generally at the center or axis of the cylindrical interior cavity 76 of the housing 24, as shown in FIGS. 2 and 3. The center tube divider 78 creates an annular space 80 between the center tube divider 78 and the inside surface of the housing 24. The fluid mixture enters the annular space 80 through the entrance conduit 26 near the outlet end 30 of the housing 24, and flows from the beginning of the fourth flow path 16d in the annular space 80 along the length of the center tube divider 78 and the housing 24 to the other closed end 32 of the housing 24.

The fluid mixture in the annular fourth flow path 16d encounters a curved or half sphere flow reverser 82 located within the cavity 76 at the closed end 32 of the housing 24. The flow reverser 82 reverses the direction of flow of the fluid mixture from the annular fourth flow path 16d and directs the fluid mixture into an open end 84 of the center tube divider 78. The fluid mixture enters and flows through the center tube divider 78 in the fifth flow path 16e. The fluid mixture continues through the center tube divider 78, and exits from the outlet port 16 as the thoroughly homogenized output fluid mixture. A downstream end portion of the center tube divider 78 forms the outlet port 28.

The center tube divider 78 is positioned at the axial center of the cylindrical cavity 76 of the housing 24 by its attachment to and orthogonal extension in a cantilever manner from the center of an end plate 86. The center tube divider 78 is hermetically attached to the end plate 86 by welding, for example. A terminal end portion of the center tube divider 78 extends beyond the end plate 86 to the outlet port 28. A flange 88 extends outward from the outlet end 30 of the housing 24, and the end plate 86 is connected to the flange 88 by nuts and bolts, for example. With the end plate 86 firmly connected to the flange 88, the center tube divider 78 is located in a stationary position at the axial center of the cylindrical cavity 76 of the housing 24.

Various static mixing structures are attached to the exterior surface of the center divider tube 78 within the annular passageway 80 to interact with the fluid mixture in the annular fourth flow path 16d. The static mixing structures create pressure and velocity changes and disruptions which lead to turbulence and shear, all of which contribute to mixing as the fluid mixture flows through the fourth flow path 16d.

As shown in FIGS. 2 and 3, the static mixing structures in the fourth flow path 16d include vanes 90 which are attached to the exterior surface of the center tube divider 78 at displaced longitudinal locations along the length of the center tube divider 78. The vanes 90 extend radially outward from the center tube divider 78 to induce swirl as well as changes in the direction, velocity and pressure of the fluid mixture in the immediate vicinity of the vanes 90. Sequential groups of vanes 90 change the direction of swirl as the fluid mixture moves along the fourth flow path 16d.

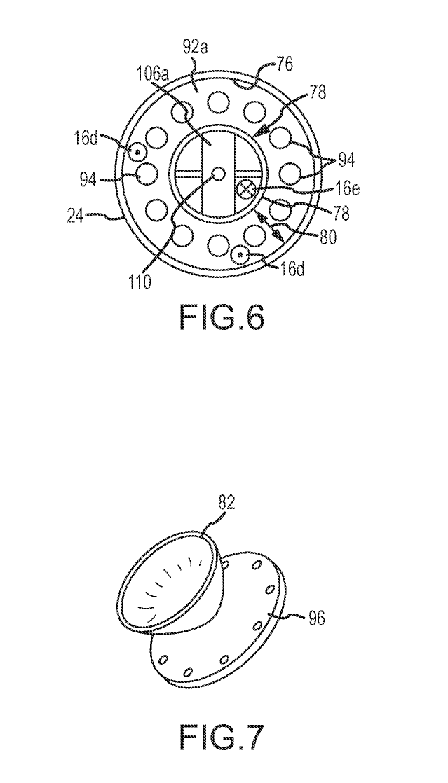

The static mixing structures in the fourth flow path 16d also include perforated annular baffle plates 92a, 92b and 92c which are connected to the center tube divider 78 at spaced apart locations along the length of the center tube divider 78 and between and adjacent to the vanes 90, as shown in FIGS. 2, 3 and 6. The annular baffle plates 92a-92c have a diameter which is very slightly smaller than the inside diameter of the cylindrical cavity 76. The annular baffle plates 92a-92c help support the center tube divider 78 within the housing 24 and also force the fluid mixture to flow through holes 94 in the perforated plates 92a-92c as the fluid mixture moves through the annular fourth flow path 16d. The fluid mixture flowing through holes 94 in the baffle plates 92a-92c experiences flow disturbances and turbulence and shear effects caused by abrupt pressure and velocity changes as the fluid passes through the holes 94. The resulting turbulence and shear effects from the static mixing structures cause further mixing and homogenization of the fluid mixture. The vanes 90 and the perforated baffle plates 92a-92c are examples of static mixing structures; other types of static mixing structures may also be used.

The curved or half sphere flow reverser 82, which reverses the direction of flow of the fluid mixture in the annular fourth flow path 16d into the fifth flow path 16e in the center tube divider 78, is attached to an end plate 96, as shown in FIGS. 2, 3 and 7. The end plate 96 is connected to a flange 98 at the closed end 32 of the housing 24 by nuts and bolts, for example. The diameter of the flow reverser 82 is slightly smaller than the inside diameter of the cylindrical cavity 76 of the housing 24, causing the flow reverser 82 to occupy essentially the entire end of the internal cylindrical cavity 76 and prevent the mixture from accumulating in any significant dead spaces. The concavity of the flow reverser 82 faces toward the open input end 84 of the center tube divider 78. The input end 84 is displaced sufficiently from the flow reverser 82 to allow enough volumetric space for the fluid mixture to flow from the annular fourth flow path 16d into the end 84 of the center tube divider 78 and establish the center fifth flow path 16e.

The fluid mixture of which enters the input end 84 of the center tube divider 78 interacts with a hollow venturi structure 100 located adjacent to the input end 84 of the center tube divider 78 as shown in FIGS. 2 and 3. The venturi structure 100 is retained in this position by a press-fit frictional relationship with the center tube divider 78. The venturi structure 100 defines a venturi 102 which causes the fluid mixture flowing through the venturi structure 100 to increase in flow velocity and decrease in pressure in the vicinity of the input end 84 of the center tube divider 78. The increase in velocity and decrease in pressure assists in drawing the fluid mixture from the flow reverser 82 into the input end 84 of the center tube divider 78, thereby facilitating the change in flow direction and avoiding dead spots in the fluid mixture as the flow reversal occurs. The change in flow rate and pressure through the venturi 102 also contributes to mixing the constituents of the fluid mixture.

A baffle assembly 104, shown in FIGS. 2, 3 and 8, is positioned within the center tube divider 78 downstream of the venturi tube 100 and adjacent to the outlet port 28. The baffle assembly 104 induces a final mixing effect on the fluid mixture before the fluid mixture exits the static mixer 10 at the outlet port 28. The baffle assembly 104 is another example of a static mixing structure.

The baffle assembly 104 is formed from multiple individual baffle plates 106a, 106b, 106c, 106d, 106e and 106f and baffle rings 108a and 108b. The baffle plates 106a-106f and baffle rings 108a and 108b are connected to one another by a center support rod 110. The baffle plates 106a-106f and the baffle rings 108a and 108b occupy a spaced apart and interspersed relationship along the length of the rod 110. The baffle plates 106a-106f and the baffle ring 108b contact the inside surface of the center tube divider 78, and are maintained in a center or coaxial alignment with the center tube divider 78. The baffle plates 106a-106f and the baffle ring 108b have an outside diameter that is slightly less than the inside diameter of the cylindrical center tube divider 78, thereby allowing the baffle plates 106a-106f and baffle ring 108b to fit within interior of the center tube divider 78.

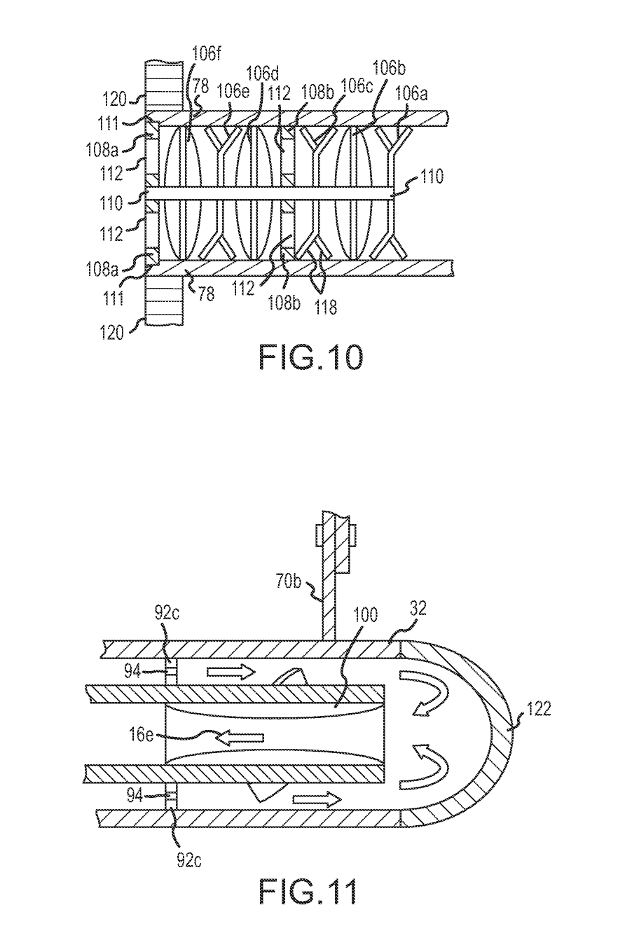

The baffle ring 108a is slightly larger in diameter than the baffle plates 106a-106f and the baffle ring 108b. The larger baffle ring 108a is retained in an annular groove 111 that extends radially outward from the end of the center tube divider 78 at the outlet port 28 (FIG. 10). Retaining the larger baffle ring 108a in the annular groove 111 prevents the baffle assembly 104 from moving in the upstream direction (left to right as shown in FIG. 3) in the center tube divider 78. A flange 120 is attached to the terminal end of the center tube divider 78 by which to connect to a conduit or other device (neither shown) to the outlet port 28, to thereby receive the output mixture created by the static mixer 10. The connection of a conduit or other device (not shown) to the flange 120 holds the baffle ring 108a in the annular groove 111 and prevents the baffle assembly 104 from moving in the downstream direction (right to left as shown in FIG. 3). In this manner, the baffle assembly 104 is retained against movement in the center tube divider 78. Removing the baffle assembly 104 from within the center tube 78 is accomplished by disconnecting the device connected to the flange 120 and withdrawing the baffle assembly 104.

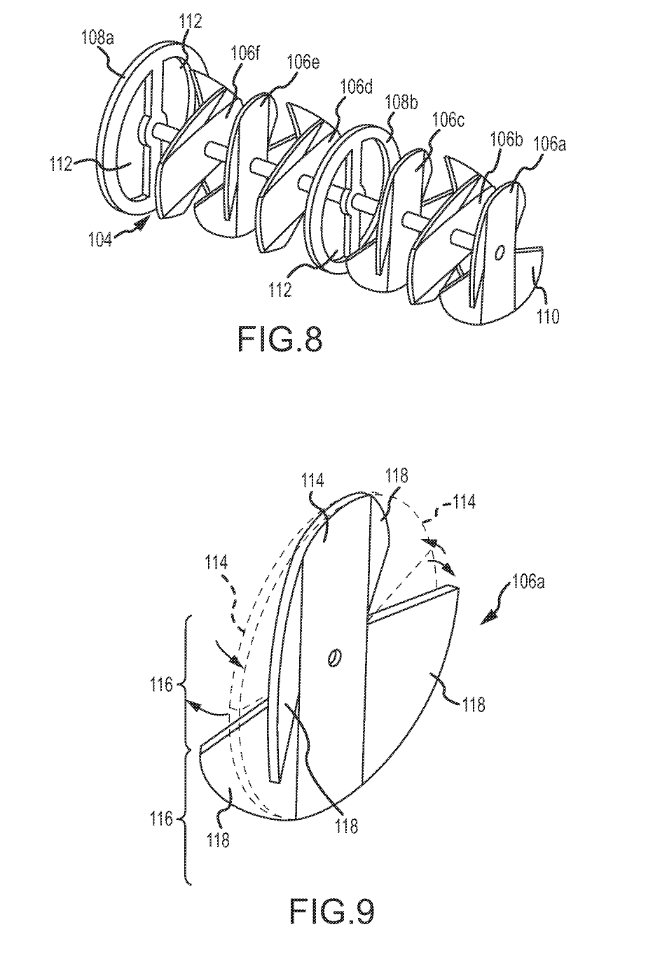

The baffle plate 106a, shown in FIG. 9, is substantially identical to the other baffle plates 106b-106f (FIG. 7) of the baffle assembly 104 (FIG. 8). The baffle plate 106a is formed by a solid disk 114 which has been cut diametrically on opposite sides almost to its center, to form two half sectors 116. Diametrically opposite end portions 118 of each half sector 116 are bent in respectively opposite directions. Furthermore, the end portions 118 of the adjoining half sector 116 are bent in respectively opposite directions. The bent portions 118 function as flow deflectors and are referred to as wing portions.

The bent wing portions 118 provide spaces for the fluid mixture to flow through and around the around baffle plate 106a when it is located inside the center tube divider 78. The bent wing portions 118 also act as vanes to induce an upstream, downstream and radial movement of the fluid passing through the spaces between the bent wing portions 118. The movement of the fluid mixture induced by each preceding baffle plate 106a-106f in the baffle assembly 104 is in an opposite direction from the movement induced by the next succeeding baffle plate. The reversing upstream, downstream and radial movement of the fluid passing through the spaces between the bent wing portions 118 is complex in its flow pattern, and that complex flow pattern creates multiple instances or zones of shear and turbulence which contribute substantially to further mixing and homogenizing of the constituents of the fluid mixture, thereby contributing to its homogeneity. Holes 114 (FIG. 8) in each of the baffle rings 108a and 108b allow the mixture to flow through those baffle rings.

An alternative to the half sphere flow reverser 82 and its connection to the end plate 96 (FIGS. 2, 3 and 7) is a half sphere flow reversing end cap 122 which is directly and permanently connected to the end 32 of the housing 24, as shown in FIG. 11. The end cap 122 is hermetically attached to the housing 24 by welding, for example. The half sphere shape of the end cap 122 reverses the flow of the fluid mixture and directs it toward the open end 84 of the center tube divider 78 in substantially the same manner described with respect to the half sphere flow reverser 82 which is connected to the end plate 96. Directly connecting the end cap 122 to the housing 24 eliminates the necessity of connecting the flange 98 to the housing and connecting the end plate 96 to the flange 98 (FIGS. 1-3).

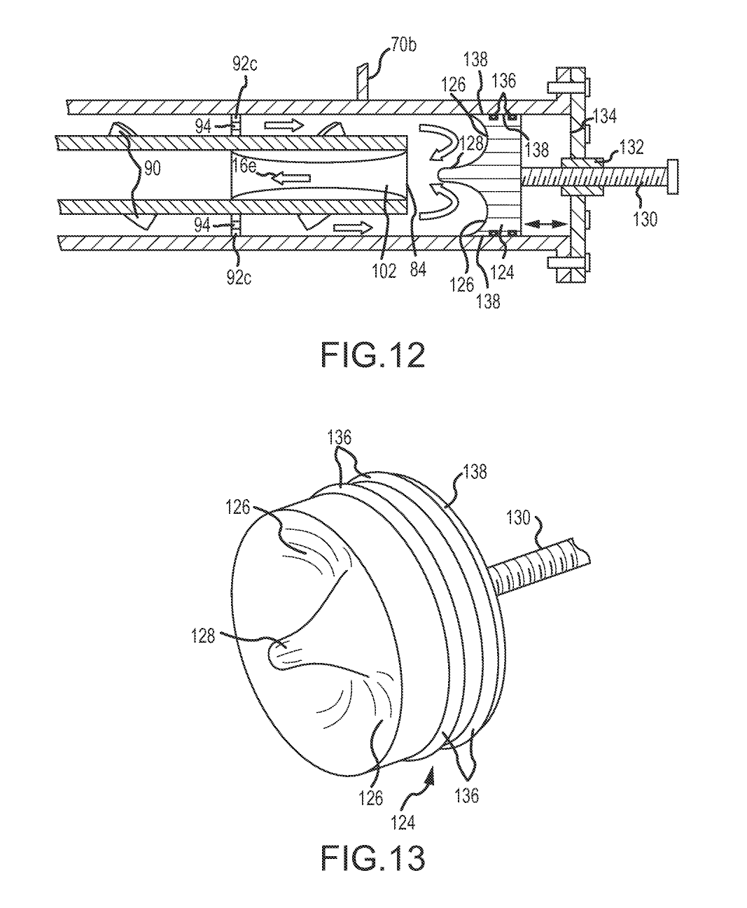

Another alternative to the half sphere flow reverser 82 and the end plate 96 is an adjustable position annular-configured flow reverser 124, shown in FIGS. 12 and 13. The annular flow reverser 124 includes an annular concave flow reversing surface 126 which transitions to a tapered center portion 128 located at the axial center of the flow reverser 124. The flow reverser 124 fits within the cylindrical interior cavity 76 of the housing 24 with its outside cylindrical surface adjacent to the housing 24, with the annular concave flow reversing surface 126 facing the open end 84 of the center tube divider 78, and with the tapered center portion 128 aligned coaxially with the open end 84 of the center tube divider 78. The annular flow reversing surface 126 receives the fluid mixture from the annular fourth flow path 16d (FIG. 3) and reverses its flow direction by movement along the flow reversing surface 126. The tapered center portion 128 directs the reversed fluid flow toward the open end 84 of the center tube divider 78.

Use of the annular flow reverser 124 also permits control over the flow rate of the fluid mixture through the mixer. The annular flow reverser 124 is movable in position within the end of the cylindrical interior cavity 76 of the housing 24. Movement of the flow reverser 124 toward and away from the open end 84 of the center tube divider 78 causes the tapered center portion 128 to move axially toward and away from the open end 84 of the center tube divider 78, respectively. Movement of the tapered center portion 128 closer to the open end 84 reduces the amount of volumetric space through which the fluid mixture flows upon entering the center tube divider, thereby diminishing the flow rate of the fluid mixture into the open end of the center tube divider. Conversely, movement of the tapered center portion 128 further from the open end 84 of the center tube divider 78 increases the amount of volumetric space through which the fluid mixture flows upon entering the open end 84 of the center tube divider 78, thereby increasing the flow rate the fluid mixture into the open end of center tube divider. Of course, there is a range of positions of the center portion 128 relative to the open end 84 of the center tube divider 78 where the flow control effects occur.

Movement of the annular flow reverser 124 is accomplished by a position adjusting device, such as a screw 130. One end of the screw 130 is attached to the annular flow reverser 124, and a threaded shank portion of the screw 130 extends through a threaded coupling 132 attached to an end plate 134. The coupling 132 is attached to the end plate 134 by welding, for example. O-rings 136 are located in circumferential grooves formed in an outside cylindrical body 138 of the annular flow reverser 124. The O-rings 136 are compressed against the inside of cylindrical surface of the housing 24 to seal the fluid mixture from leaking past the annular flow reverser 124 and interacting with the threads of the screw 130 or the coupling 132 or accumulating in the space between the flow reverser 124 and the end plate 134. The end plate 134 is attached to the flange 98 at the end of the housing 24, in a similar manner as the end plate 96 is attached, for example by nuts and bolts (FIGS. 1-3). Rotating the end of the screw 130 at the exterior of the mixer, causes the position of the annular flow reverser 124 to change relative to the end plate 134, which has the effect of changing the position of the tapered center portion 128 relative to the open end 84 of the center tube divider 78, thereby controlling the flow. The O-rings 136 slide along the inside cylindrical surface of the housing 24 as the annular flow reverser 124 is adjusted in position.

Closable ports (not shown) can be formed in each of the housings 14 and 16, and in the conduits 22 and 26, and in the center tube divider 78 to provide access to the fluid mixture flowing in the flow paths 16a-16e. Such access ports can be used to sample the pressure at locations along the flow paths, to draw samples of the fluid mixture at the locations, and to inject slight amounts of additives into the fluid mixture moving through the mixer. Further, gaskets (not shown) are clamped between the various mating surfaces described above, in order to create a fluid tight seal and prevent leaks of the fluid mixture from the mixer 10 at those locations.

The static mixer 10 as described above thoroughly mixes and homogenizes the fluid mixture supplied to the inlet port 12 as the fluid mixture passes through the mixer 10 before it exits from the outlet port 28. A high degree of homogenization of the fluid mixture is achieved by the substantial turbulence induced by four complete flow reversals in the five flow paths 16a-16e, and by the series of static mixing structures 54, 56, 60, 62, 64, 72, 74, 82, 90, 92a-92c, 94, 100 and 104 which are interposed in the flow paths 16a-16e.

In the case where one of the constituents of the fluid mixture includes solid particulate matter, agglomerations of particulate matter become highly subdivided and evenly dispersed within the fluid mixture. In the case where one of the constituents of the fluid mixture is a fluid of substantially reduced viscosity, the different viscosity than a carrier fluid, the fluids become evenly dispersed within the fluid mixture. The mixing or homogeneity results from shear forces and turbulence created by changes in flow direction, flow rate, flow deflection, flow division and pressure variations in the fluid mixture created by the flow reversals in the flow paths 16a-16e, as well as the static mixing structures included in those flow paths 16a-16e.

The static mixer 10 is compact in size and subjects the fluid mixture to an overall flow path length which is the total of the lengths of the flow paths 16a-16e, thereby achieving a greater mixing effect. The compact size of the static mixer 10 facilitates its use in applications and environments where space is limited, such as on a relatively small drilling rig which is typically used to drill horizontal bores in the earth in residential and commercial areas to contain electrical distribution cables and electrical and optical communication cables. The modular nature of the static mixer 10 facilitates the assembly of the static mixer 10, as well as its disassembly if it becomes necessary to replace or change any of its constituent parts.

Many other advantages and improvements will become apparent upon fully appreciating the significant aspects of the invention. Presently preferred embodiments of the invention and its many improvements have been described with a degree of particularity. This description is of preferred examples of implementing the invention, and is not necessarily intended to limit the scope of the invention. The scope of the invention is defined by the scope of the following claims.

What is claimed is:

1. A static mixer for mixing constituents of an input fluid mixture into a more homogenized output fluid mixture, comprising:
a first elongated tubular housing which defines an elongated internal cavity extending between a first end of the first housing and a second opposite end of the first housing;
an inlet port connected to the first end of the first housing and adapted to receive the input fluid mixture and to conduct the input fluid mixture into the internal cavity at the first end of the first housing;
a second elongated tubular housing which defines an elongated internal cavity extending between a first end of the second housing and a second opposite end of the second housing;
a conduit connected between the first and second housings to conduct the fluid mixture from the internal cavity of the first housing to the internal cavity of the second housing;
an outlet port connected to the second end of the second housing and adapted to conduct the fluid mixture from the internal cavity of the second housing as the output fluid mixture; and
first and second dividers are respectively located within the internal cavities of the first and second housings to divide each internal cavity into a plurality of separate and sequential flow paths for the fluid mixture, each separate flow path extending substantially between the first and second ends of each housing, each flow path reversing direction substantially adjacent to an end of each housing, each flow path in the sequence in each housing conducting the fluid mixture in a direction opposite of the fluid mixture conducted by one of a preceding or succeeding flow path in each housing.

2. A static mixer as defined in claim 1, wherein:
the inlet port delivers the input fluid mixture into a beginning one of the sequential flow paths in the first housing; and
the outlet port conducts the output fluid mixture from an ending one of the sequential flow paths in the second housing.

3. A static mixer as defined in claim 2, wherein:
the internal cavity in at least one of the first or second housings is an elongated cylindrical cavity; and
the divider in the internal cavity of the one housing is a multi-fin structure defined by a plurality of at least three fin plates which extend radially outward from an axis of the cylindrical internal cavity at different circumferentially spaced locations to divide the cylindrical cavity into a plurality of at least three flow paths which are sector-shaped in cross-section, at least some of the plurality of fin plates terminating longitudinally short of the ends of the one housing to create pass-through openings from one flow path to the next sequential flow path in the one housing.

4. A static mixer as defined in claim 3, wherein:
the multi-fin structure further includes transverse end plates connected to opposite ends of the fin plates to define the pass-through openings between the longitudinally short ends of the fin plates and the end plates;
one end of the one housing is removable to gain access to the internal cavity of the one housing; and
the multi-fin structure is insertable into and removable from the internal cavity of the one housing through the removable end of the one housing.

5. A static mixer as defined in claim 3, wherein:
the conduit is connected adjacent to the second ends of the first and second housings;
the one housing in which the multi-fin structure is positioned is the first housing; and
the conduit connects to the first housing in alignment with a terminal end of an ending one of the sequential sector-shaped flow paths in the first housing.

6. A static mixer as defined in claim 3, wherein:
each pass-through opening has a cross-sectional size which is greater than cross-sectional size of the sector shaped flow path.

7. A static mixer as defined in claim 3, further comprising:
static mixing structures connected to the fin plates within at least one of the sector-shaped flow paths are adapted to induce turbulence and shear effects in the fluid mixture flowing past the static mixing structures.

8. A static mixer as defined in claim 7, wherein:
the static mixing structures include at least one of vanes which extend outward from the fin plates into the sector shaped flow paths or perforated baffle plates which extend entirely across the sector shaped flow path.

9. A static mixer as defined in claim 2, wherein:
the internal cavity in at least one of the first or second housings is an elongated cylindrical cavity; and
the divider in the internal cavity of the one housing is a hollow center tube located at and extending along an axis of the cylindrical internal cavity from one end of the housing and terminating at an open end which is separated from the other end of the housing, the center tube dividing the cylindrical internal cavity into an annular-shaped flow path at an exterior of the center tube and a center flow path within the hollow center tube.

10. A static mixer as defined in claim 9, further comprising:
static mixing structures connected to the exterior of the center tube within the annular-shaped flow path and adapted to induce turbulence and shear effects in the fluid mixture flowing past the static mixing structures.

11. A static mixer as defined in claim 10, wherein:
the static mixing structures include vanes which extend radially outward from the exterior of the center tube toward the housing.

12. A static mixer as defined in claim 10, wherein:
the static mixing structures include annular-shaped perforated baffle plates which extend radially outward from the exterior of the center tube to contact the cylindrical internal cavity of the one housing.

13. A static mixer as defined in claim 12, wherein:
the center tube is connected in a cantilever manner to extend from the one end of the one housing;
one end of the one housing is removable to gain access to the internal cavity of the one housing;
the annular-shaped baffle plates contact the one housing to contribute to the support of the cantilever-connected center tube within the cylindrical internal cavity of the one housing; and
the center tube and the connected annular-shaped perforated baffle plates are insertable into and removable from the internal cavity of the one housing through the removable end of the one housing.

14. A static mixer as defined in claim 9, further comprising:
a concave-shaped flow reverser positioned within the internal cavity with the concave shape spaced from and facing toward the open end of the center tube, the flow reverser adapted to direct the fluid mixture in the annular flow path into the open end of the center tube.

15. A static mixer as defined in claim 14, wherein:
the flow reverser is connected to the other end of the one housing which is opposite of the end to which the center tube is connected;
the other end of the one housing is removable to gain access to the internal cavity of the one housing; and
the flow reverser is insertable into and removable from the internal cavity of the one housing through the removable other end of the one housing.

16. A static mixer as defined in claim 14, wherein:
the flow reverser comprises a concave-shaped end cap permanently connected to the other end of the one housing with the concave shape facing toward the open end of the center tube.

17. A static mixer as defined in claim 14, wherein:
the concave shape of the flow reverser is annular with a center portion that projects axially within the internal cavity of the one housing in a direction toward the open end of the center tube, the annular concave shape of the flow reverser surrounding the center portion.

18. A static mixer as defined in claim 17, wherein:
the flow reverser is movably positioned within the internal cavity of the one housing to establish a range of distances between the center portion of the flow reverser and the open end of the center tube.

19. A static mixer as defined in claim 18, further comprising:
a position adjusting device connected to the flow reverser within the internal cavity and operative exteriorly of the one housing to move the flow reverser within the internal cavity over the range of distances.

20. A static mixer as defined in claim 14, further comprising:
a venturi structure positioned within the center tube adjacent to the open end of the center tube, the venturi structure defining a venturi which is adapted for creating a reduced pressure in the fluid mixture in the center flow path adjacent to the open end of the center tube to draw the fluid mixture into the center flow path at the open end of the center tube.

21. A static mixer as defined in claim 9, further comprising:
a venturi structure positioned within the center tube adjacent to the open end of the center tube, the venturi structure defining a venturi which is adapted for creating a reduced pressure in the fluid mixture in the center flow path adjacent to the open end of the center tube to draw the fluid mixture into the center flow path at the open end of the center tube.

22. A static mixer as defined in claim 21, further comprising:
a baffle assembly positioned within the center tube at a location downstream relative to the venturi structure in the center flow path, the baffle assembly including a plurality of baffle plates; and wherein:
each of the baffle plates includes a plurality of wing portions and a transverse portion, each of the wing portions extends at an angle relative to a transverse portion of the baffle plate;
adjacent wing portions extend in opposite directions relative to the transverse portion to define openings through the baffle plates, the openings and the extensions of the wing portions are adapted to induce turbulence and shear effects in the fluid mixture flowing through the openings in the center flow path; and
the transverse portion of each baffle plate extends transversely across the center tube.

23. A static mixer as defined in claim 9, further comprising:
a baffle assembly positioned within the center tube at a location downstream relative to the open end of the center tube, the baffle assembly including a plurality of baffle plates which are each adapted to induce turbulence and shear effects in the fluid mixture flowing around the winged baffle plates.

24. A static mixer as defined in claim 9, wherein:
the conduit is connected adjacent to the second ends of the first and second housings;
the one housing in which the center tube is positioned is the second housing;
the conduit connects to the second housing to deliver the fluid mixture into a beginning location of the annular flow path; and
the center tube is connected to deliver the fluid mixture from the center flow path to the exit port.

25. A method of creating a homogeneous output fluid mixture from an input fluid mixture having substantially less homogeneity, comprising:
conducting the input fluid mixture through a static mixing apparatus as defined in claim 1 to create the homogeneous output mixture.
